(19) United States
(12) Patent Application Publication
(10) Pub. No.: US 2026/0161123 A1
(43) Pub. Date: Jun. 11, 2026

(54) IMAGE FORMING APPARATUS

(71) Applicants: Takaaki TAWADA, Kanagawa (JP); Kazuhiko WATANABE, Tokyo (JP); Hirofumi FUJII, Kanagawa (JP); Hiroki ISHII, Kanagawa (JP)

(72) Inventors: Takaaki TAWADA, Kanagawa (JP); Kazuhiko WATANABE, Tokyo (JP); Hirofumi FUJII, Kanagawa (JP); Hiroki ISHII, Kanagawa (JP)

(21) Appl. No.: 19/398,093

(22) Filed: Nov. 24, 2025

(30) Foreign Application Priority Data
Dec. 5, 2024 (JP) 2024-212057

(51) Int. Cl. G03G 15/00; G03G 15/01; G03G 15/08; G03G 15/16

(52) U.S. Cl. CPC G03G 15/5012; G03G 15/0131; G03G 15/0189; G03G 15/0844; G03G 15/161; G03G 15/553; G03G 2215/1661

(57) ABSTRACT

An image forming apparatus is provided including a photoconductor drum, an image forming unit to develop a toner image on the photoconductor drum, an intermediate transfer belt to which the toner image is primarily transferred from the photoconductor drum, a cleaning blade to remove toner remaining on the intermediate transfer belt, and circuitry configured to: count a travel distance of the intermediate transfer belt; predict a cumulative consumption amount of a lubricant on the intermediate transfer belt based on the travel distance counted; determine whether the cumulative consumption amount predicted is equal to or more than a predetermined amount; and delay a progress speed of a job when the cumulative consumption amount is determined to be equal to or more than the predetermined amount.

### CROSS-REFERENCE TO RELATED APPLICATION

This patent application is based on and claims priority pursuant to 35 U.S.C. § 119(a) to Japanese Patent Application No. 2024-212057, filed on Dec. 5, 2024, in the Japan Patent Office, the entire disclosure of which is hereby incorporated by reference herein.

### BACKGROUND

### Technical Field

The present disclosure relates to an image forming apparatus.

### Related Art

In recent years, with the increase in speed of an image forming apparatus and the increase in environmental awareness, the life of the image forming apparatus has been prolonged. In order to prolong the life of a photoconductor, a lubricant applicator that supplies lubricant to the photoconductor is provided. In this case, the lubricant supplied to the photoconductor also transfers to an intermediate transfer belt on the downstream side, and thus the lubricant affects the state of the intermediate transfer belt. In addition, problems such as filming by the lubricant, cleaning failure due to insufficient lubrication of the intermediate transfer belt, and turnover of the cleaning blade occur. In particular, in a case where there is no lubricant applicator that supplies lubricant to the intermediate transfer belt, the intermediate transfer belt is easily affected by the lubricant supplied to the photoconductor, and is affected by a change in the state of lubricant application to the photoconductor. It is generally difficult to accurately predict the life of the lubricant since the consumption amount of the lubricant varies depending on the use environmental conditions of the apparatus, the operation mode, the wear state of the lubricant, and the like. Therefore, early maintenance has been usually performed before the lubricant runs out.

However, with the recent increase in environmental awareness, lubricant is used until fully consumed. In such a situation, the apparatus may operate in a state in which the lubricant has run out, and a disadvantage of lubricant depletion newly occurs. When the lubricant is depleted, lubrication of the intermediate transfer belt is deteriorated, and turnover of the cleaning blade with respect to the intermediate transfer belt may occur. When the turnover occurs in the cleaning blade, a large defect such as stop of the apparatus, breakage of the intermediate transfer belt, and contamination and breakage of other units near an intermediate transfer unit occurs. If the depletion of the lubricant is predicted early and the apparatus is stopped early, a waste of resources such as a replacement product and an inefficient state in which the user cannot work due to the stop of the apparatus also occur.

### SUMMARY

Embodiments of the present invention provide an image forming apparatus including a photoconductor drum, an image forming unit to develop a toner image on the photoconductor drum, an intermediate transfer belt to which the toner image is primarily transferred from the photoconductor drum, a cleaning blade to remove toner remaining on the intermediate transfer belt, and circuitry configured to: count a travel distance of the intermediate transfer belt; predict a cumulative consumption amount of a lubricant on the intermediate transfer belt based on the travel distance counted; determine whether the cumulative consumption amount predicted is equal to or more than a predetermined amount; and delay a progress speed of a job when the cumulative consumption amount is determined to be equal to or more than the predetermined amount.

According to embodiments of the present invention, turnover of a cleaning blade can be suppressed while using lubricant until almost fully consumed, and a decrease in work efficiency due to a sudden machine stop can be suppressed.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming apparatus according to a first embodiment;

FIG. 2 is a block diagram illustrating a hardware configuration of the image forming apparatus according to the first embodiment;

FIG. 3 is a diagram illustrating a configuration of functional blocks in the image forming apparatus according to the first embodiment;

FIG. 4 is a diagram illustrating a relationship between a travel distance and a lubricant consumption rate;

FIG. 5 is a diagram illustrating a lookup table of a lubricant consumption rate associated with a travel distance and an environmental temperature;

FIG. 6 is a diagram illustrating a lookup table of environmental coefficients associated with a travel distance and an environmental temperature;

FIG. 7 is a diagram illustrating an operation of linear velocity control after lubricant depletion determination in the image forming apparatus according to the first embodiment;

FIG. 8 is a diagram describing turnover of a cleaning blade and remedy thereof in an image forming apparatus according to a second embodiment;

FIG. 9 is a diagram illustrating an operation of control of the number of continuous printed sheets after lubricant depletion determination in the image forming apparatus according to the second embodiment; and

FIG. 10 is a diagram illustrating an operation of toner purge control after lubricant depletion determination in an image forming apparatus according to a third embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, an image forming apparatus according to an embodiment of the present invention will be described in detail with reference to the drawings. The present disclosure, however, is not limited to the following embodiment, and components of the following embodiment include components that may be easily conceived by those skilled in the art, components being substantially the same, and components being within equivalent ranges. Furthermore, various omissions, substitutions, changes, and combinations of the components can be made without departing from the gist of the following embodiment.

### First Embodiment

### Overall Configuration of Image Forming Apparatus

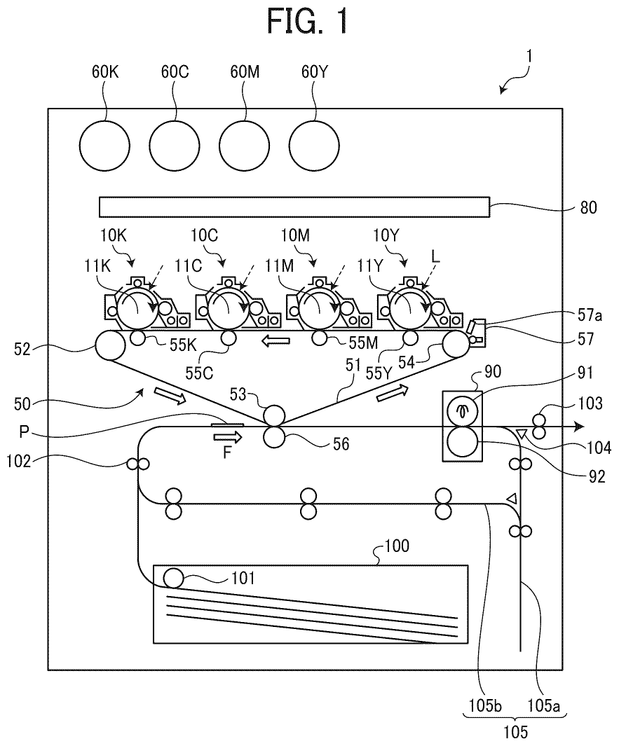

FIG. 1 is a diagram illustrating an overall configuration of an image forming apparatus according to a first embodiment. With reference to FIG. 1, a description will be given of the overall configuration of an image forming apparatus 1 according to the present embodiment.

The image forming apparatus 1 illustrated in FIG. 1 is an electrophotographic image forming apparatus that transfers a toner image developed based on an electrostatic latent image on a photoconductor drum to a recording sheet (recording material). The image forming apparatus 1 includes image forming units 10C, 10K, 10M, and 10Y, an optical writing unit 80, a transfer unit 50, replenishment toner bottles 60C, 60K, 60M, and 60Y, a fixing device 90, a sheet-feeding cassette 100, a registration roller pair 102, a sheet ejection roller pair 103, a switching claw 104, and a reverse re-conveying device 105.

The image forming units 10C, 10K, 10M, and 10Y are units for forming toner images of cyan (C), black (K), magenta (M), and yellow (Y), respectively. For example, the image forming unit 10Y, the image forming unit 10M, the image forming unit 10C, and the image forming unit 10K are arranged in this order from the upstream side along the upper traveling side of an intermediate transfer belt 51 to be described later, and are configured as a tandem image forming unit. Each of the image forming units 10C, 10K, 10M, and 10Y is detachably provided to a main body of the image forming apparatus 1. The image forming units 10C, 10K, 10M, and 10Y include photoconductor drums 11C, 11K, 11M, and 11Y, respectively. Note that, regarding the image forming units 10C, 10K, 10M, and 10Y, in a case where any of the image forming units is indicated or the image forming units are collectively referred to, an “image forming unit 10” is simply used. Further, regarding the photoconductor drums 11C, 11K, 11M, and 11Y, in a case where any of the photoconductor drums is indicated or the photoconductor drums are collectively referred to, a “photoconductor drum 11” is simply used.

The image forming unit 10 is a unit that charges the photoconductor drum 11 and develops and visualizes the latent image formed by the optical writing unit 80 with a developer containing toner.

The photoconductor drum 11 is a drum-shaped latent image bearer in which an organic photosensitive layer is formed on a surface of a drum base. The photoconductor drum 11 is rotationally driven in a clockwise direction in a sheet view of FIG. 1 by a driving unit.

The optical writing unit 80 is a unit that is provided on the image forming units 10C, 10K, 10M, and 10Y and writes a latent image on the surface of the charged photoconductor drum 11. The optical writing unit 80 optically scans the surfaces of the photoconductor drums 11C, 11K, 11M, and 11Y with laser light L emitted from a laser diode based on image data received from an external device such as a personal computer (PC). Specifically, the optical writing unit 80 irradiates the surface of the photoconductor drum 11 with laser light L emitted from a light source via a plurality of optical lenses and mirrors while polarizing the laser light in a main scanning direction with a polygon mirror rotationally driven by a polygon motor. By the optical scanning by the optical writing unit 80, electrostatic latent images for C, K, M, and Y are formed on the surfaces of the photoconductor drums 11C, 11K, 11M, and 11Y. Specifically, a potential attenuates at a portion irradiated with the laser light from the optical writing unit 80 in the entire region of the uniformly charged surface of the photoconductor drum 11. As a result, the potential of the portion irradiated with the laser light becomes smaller than the potential of other portions (background portion), and as a result, an electrostatic latent image is formed. Note that the optical writing unit 80 may perform optical writing by light emitting diode (LED) light emitted from a plurality of LEDs of an LED array.

The transfer unit 50 is a unit that secondarily transfers the toner image primarily transferred from the photoconductor drum 11 to a recording sheet P by the intermediate transfer belt 51 that is an endless belt member that is an image bearer and an intermediate transfer body. As illustrated in FIG. 1, the transfer unit 50 includes the intermediate transfer belt 51, a driving roller 52, a secondary transfer counter roller 53, a cleaning backup roller 54, primary transfer rollers 55C, 55K, 55M, and 55Y, a secondary transfer roller 56, and a cleaning device 57.

The intermediate transfer belt 51 is a belt member that is stretched by the driving roller 52, the secondary transfer counter roller 53, the cleaning backup roller 54, and the primary transfer rollers 55C, 55K, 55M, and 55Y disposed inside, and moves endlessly counterclockwise in a sheet view of FIG. 1 by rotational driving of the driving roller 52. The intermediate transfer belt 51 secondarily transfers the toner image primarily transferred from the photoconductor drum 11 to the recording sheet P.

The driving roller 52 is a roller that is disposed inside the intermediate transfer belt 51 and moves the intermediate transfer belt 51 endlessly by rotational driving.

The secondary transfer counter roller 53 is a roller that is disposed inside the intermediate transfer belt 51 and sandwiches the intermediate transfer belt 51 with the secondary transfer roller 56 facing the secondary transfer counter roller 53.

The cleaning backup roller 54 is a roller that is disposed inside the intermediate transfer belt 51 and cleans the toner remaining on the intermediate transfer belt 51 after the secondary transfer together with the cleaning device 57.

The primary transfer rollers 55C, 55K, 55M, and 55Y are rollers that sandwich the endlessly moving intermediate transfer belt 51 together with the photoconductor drums 11C, 11K, 11M, and 11Y, respectively. As a result, primary transfer nips for C, K, M, and Y are formed in which the front surface of the intermediate transfer belt 51 comes into contact with the photoconductor drums 11C, 11K, 11M, and 11Y. Note that, regarding the primary transfer rollers 55C, 55K, 55M, and 55Y, in a case where any primary transfer roller is indicated or the primary transfer rollers are collectively referred to, a “primary transfer roller 55” is simply used.

The secondary transfer roller 56 is a transfer member that is disposed outside the intermediate transfer belt 51 and sandwiches the intermediate transfer belt 51 together with the secondary transfer counter roller 53 inside the intermediate transfer belt 51. As a result, the secondary transfer nip is formed in which the front surface of the intermediate transfer belt 51 comes into contact with the secondary transfer roller 56.

The toner image on the intermediate transfer belt 51 brought into close contact with the recording sheet P at the secondary transfer nip is secondarily transferred onto the recording sheet P by action of the secondary transfer electric field and nip pressure of the secondary transfer nip. When the recording sheet P on which a full-color toner image or a monochrome toner image is formed on the front surface in this manner passes through the secondary transfer nip, the recording sheet P is curvature-separated from the secondary transfer roller 56 and the intermediate transfer belt 51.

The cleaning device 57 is a device that cleans the toner remaining on the intermediate transfer belt 51 after the secondary transfer together with the cleaning backup roller 54. As illustrated in FIG. 1, the cleaning device 57 includes a cleaning blade 57a.

The cleaning blade 57a is in contact with the front surface of the intermediate transfer belt 51 from the counter direction with respect to the moving direction of the intermediate transfer belt 51. According to such an aspect, the toner remaining on the intermediate transfer belt 51 can be removed by the movement of the intermediate transfer belt 51.

The replenishment toner bottles 60C, 60K, 60M, and 60Y are bottles that contain replenishment toners of the respective colors.

The fixing device 90 is a device that fixes the toner image onto the recording sheet P by heating and pressurizing the recording sheet P onto which the toner image has been secondarily transferred at the secondary transfer nip.

As illustrated in FIG. 1, the fixing device 90 includes a fixing roller 91 and a pressure roller 92.

The fixing roller 91 is a roller including a heat source such as a halogen lamp. The pressure roller 92 is a roller that comes into contact with the fixing roller 91 at a predetermined pressure. A fixing nip is formed by the fixing roller 91 and the pressure roller 92.

The recording sheet P fed into the fixing device 90 is sandwiched by the fixing nip in a posture in which a surface on which the unfixed toner image has been secondarily transferred is in close contact with the fixing roller 91. Then, the toner in the toner image is softened by influence of heating and pressurization by the fixing roller 91 and the pressure roller 92, and the toner image is fixed.

The sheet-feeding cassette 100 is a cassette that is disposed below the transfer unit 50 and accommodates a plurality of the recording sheets P as target transfer members in a sheet bundle state. The sheet-feeding cassette 100 includes a sheet-feeding roller 101.

The sheet-feeding roller 101 is a roller that comes into contact with the uppermost recording sheet P of the sheet bundle accommodated in the sheet-feeding cassette 100 and rotates at a predetermined timing to feed the recording sheet P toward the registration roller pair 102 on a sheet-feeding path.

The registration roller pair 102 is a roller pair disposed near the end of the sheet-feeding path for the recording sheet P. The registration roller pair 102 immediately stops the rotation when the recording sheet P fed from the sheet-feeding cassette 100 by the sheet-feeding roller 101 is sandwiched. Then, the registration roller pair 102 resumes rotational driving at a timing at which the sandwiched recording sheet P can be synchronized with the toner image on the intermediate transfer belt 51 in the secondary transfer nip, and feeds the recording sheet P toward the secondary transfer nip.

The sheet ejection roller pair 103 is a roller pair that ejects the recording sheet P, which passes through the fixing device 90 and is conveyed to an ejection path by the switching claw 104, to the outside of the image forming apparatus 1.

The switching claw 104 is a claw member that switches whether to convey the recording sheet P having passed through the fixing device 90 to the ejection path toward the sheet ejection roller pair 103 or a return path toward the reverse re-conveying device 105.

The reverse re-conveying device 105 is a device that reverses and re-feeds the recording sheet P that has passed through the fixing device 90 and been conveyed to the return path when double-sided printing is performed on the recording sheet P. As illustrated in FIG. 1, the reverse re-conveying device 105 includes a switchback section 105a and a re-conveying section 105b.

The switchback section 105a is a part in which the entered recording sheet P is switched back and conveyed to the re-conveying section 105b. The re-conveying section 105b is a conveyance path for conveying the recording sheet P switched back by the switchback section 105a to the sheet-feeding path again.

In the case of single-sided printing, the recording sheet P having passed through the fixing device 90 is guided toward the ejection path by the switching claw 104. As a result, the recording sheet P is ejected to the outside of the image forming apparatus 1 via the sheet ejection roller pair 103.

On the other hand, in the case of double-sided printing, the recording sheet P having passed through the fixing device 90 is guided toward the return path by the switching claw 104. The recording sheet P guided to the return path is conveyed to the switchback section 105a of the reverse re-conveying device 105. The recording sheet P having entered the switchback section 105a is switched back at the switchback section 105a. As a result, the recording sheet P enters the re-conveying section 105b while being turned upside down with the rear end facing forward.

Then, the recording sheet P is conveyed again from the re-conveying section 105b toward the sheet-feeding path. Thereafter, the recording sheet P passes through the registration roller pair 102 and the secondary transfer nip, a toner image is also transferred to the back surface, and then the toner image is fixed in the fixing device 90. Then, the recording sheet P is ejected to the outside of the image forming apparatus 1 via the sheet ejection roller pair 103.

### Hardware Configuration of Image Forming Apparatus

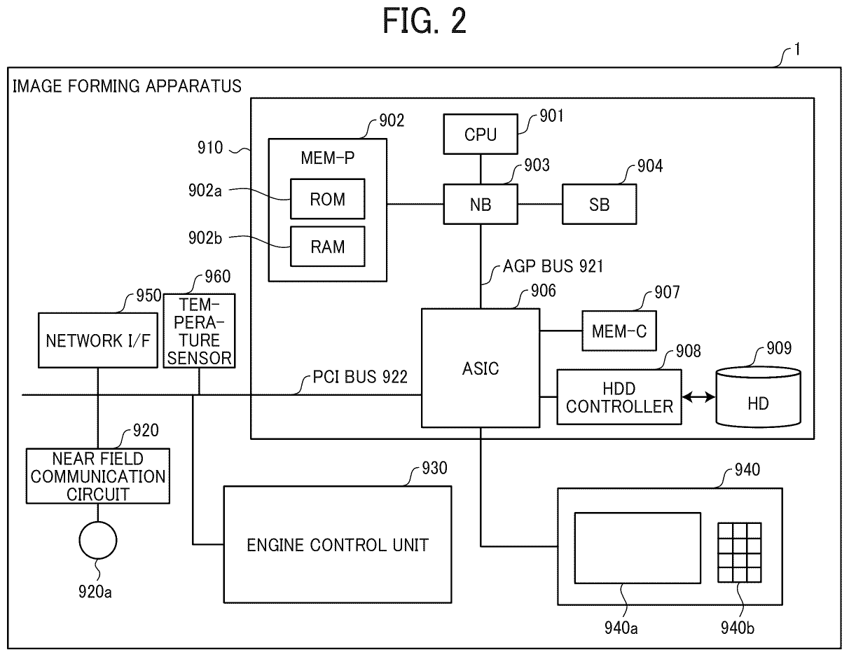

FIG. 2 is a block diagram illustrating a hardware configuration of an image forming apparatus according to the first embodiment of the present disclosure. The hardware configuration of the image forming apparatus 1 according to the present embodiment will be described with reference to FIG. 2.

As illustrated in FIG. 2, the image forming apparatus 1 includes a controller 910, a near field communication circuit 920, an engine control unit 930, an operation panel 940, a network interface (I/F) 950, and a temperature sensor 960.

The controller 910 includes a central processing unit (CPU) 901 that is a main part of a computer, a system memory (MEM-P) 902, a north bridge (NB) 903, a south bridge (SB) 904, an application specific integrated circuit (ASIC) 906, a local memory (MEM-C) 907, a hard disk drive (HDD) controller 908, and a hard disk (HD) 909. Among them, the NB 903 and the ASIC 906 are connected by an accelerated graphics port (AGP) bus 921.

The CPU 901 is an arithmetic device that performs overall control of the image forming apparatus 1. The NB 903 is a bridge for connecting the CPU 901, the MEM-P 902, the SB 904, and the AGP bus 921, and includes a memory controller that controls reading and writing from and to the MEM-P 902, a peripheral component interconnect (PCI) master, and an AGP target.

The MEM-P 902 includes a read only memory (ROM) 902a which is a memory for storing a program and data for realizing each function of the controller 910, and a random access memory (RAM) 902b which is used as a drawing memory or the like at the time of developing the program and the data and printing the memory. Note that the program stored in the RAM 902b may be provided by being recorded in a computer-readable recording medium such as a compact disc read only memory (CD-ROM), a compact disc recordable (CD-R), or a digital versatile disc (DVD) as a file in an installable format or an executable format.

The SB 904 is a bridge for connecting the NB 903 to a PCI device, a peripheral device, and the like. The ASIC 906 is an integrated circuit (IC) for image processing having a hardware element for image processing, and functions as a bridge that connects the AGP bus 921, the PCI bus 922, the HDD controller 908, and the MEM-C 907. The ASIC 906 includes a PCI target, an AGP master, an arbiter (ARB) that forms the core of the ASIC 906, a memory controller that controls the MEM-C 907, a plurality of direct memory access controllers (DMAC) that rotates image data by hardware logic or the like, and a PCI unit that performs data transfer between a scanner unit 931 and a printer unit 932 via the PCI bus 922. Note that an interface of a universal serial bus (USB) or an interface of Institute of Electrical and Electronics Engineers 1394 (IEEE 1394) may be connected to the ASIC 906.

The MEM-C 907 is a local memory used as a copy image buffer and a code buffer. The HD 909 is a storage for accumulating image data, accumulating font data used at the time of printing, and accumulating forms. The HDD controller 908 is a controller that controls reading or writing of data with respect to the HD 909 under the control of the CPU 901. The HDD controller 908 and the HD 909 may be solid state drives (SSDs).

The AGP bus 921 is a bus interface for a graphics accelerator card proposed for speeding up graphics processing, and can speed up the graphics accelerator card by directly accessing the MEM-P 902 with high throughput.

The near field communication circuit 920 is a communication circuit such as near field communication (NFC) or Bluetooth (registered trademark). The near field communication circuit 920 is electrically connected to the ASIC 906 via the PCI bus 922. An antenna 920a for wireless communication is connected to the near field communication circuit 920.

The engine control unit 930 is a control unit that controls the image forming unit 10, the transfer unit 50, the optical writing unit 80, the fixing device 90, and the like described above in FIG. 1 to print an image on the recording sheet P.

The operation panel 940 includes a panel display unit 940a such as a touch panel that displays a current setting value, a selection screen, or the like and receives an input from a user, and hard keys 940b including a numeric keypad that receives a setting value of a condition related to image formation such as a density setting condition, a start key that receives a copy start instruction, and the like.

The image forming apparatus 1 can sequentially switch and select a document box function, a copy function, a printer function, and a facsimile function by an application switching key of the operation panel 940. A document box mode is set when the document box function is selected, a copy mode is set when the copy function is selected, a printer mode is set when the printer function is selected, and a facsimile mode is set when the facsimile function is selected.

The network I/F 950 is an interface for performing data communication via a network, and is an interface capable of performing communication conforming to, for example, Ethernet (registered trademark), Transmission Control Protocol (TCP)/Internet Protocol (IP), or the like. The network I/F 950 is electrically connected to the ASIC 906 via the PCI bus 922.

The temperature sensor 960 is a sensor that is installed inside the main unit of the image forming apparatus 1 and detects the temperature of the use environment of the intermediate transfer belt 51.

The hardware configuration of the image forming apparatus 1 illustrated in FIG. 2 is an example, and it is not necessary to include all the components illustrated in FIG. 2, or other components may be included.

### Configuration and Operation of Functional Blocks of Image Forming Apparatus

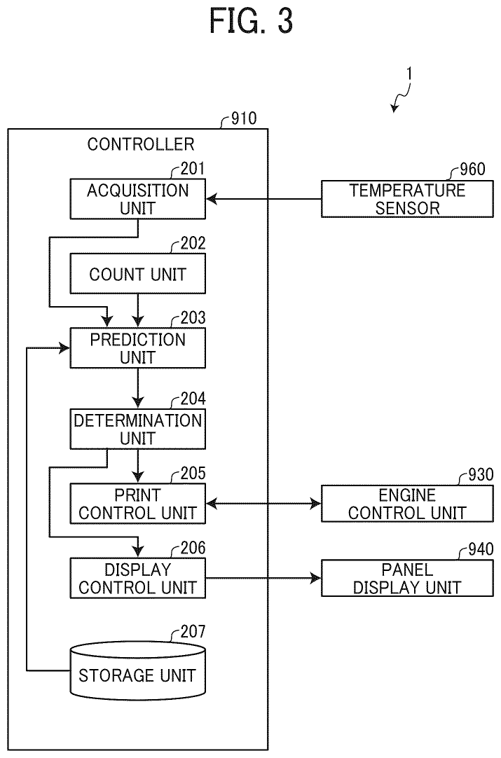

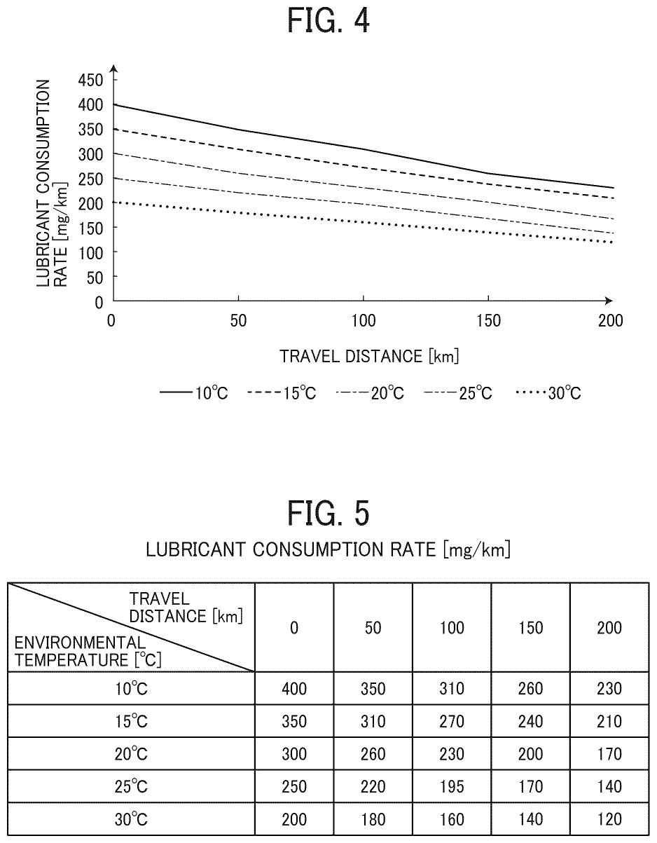

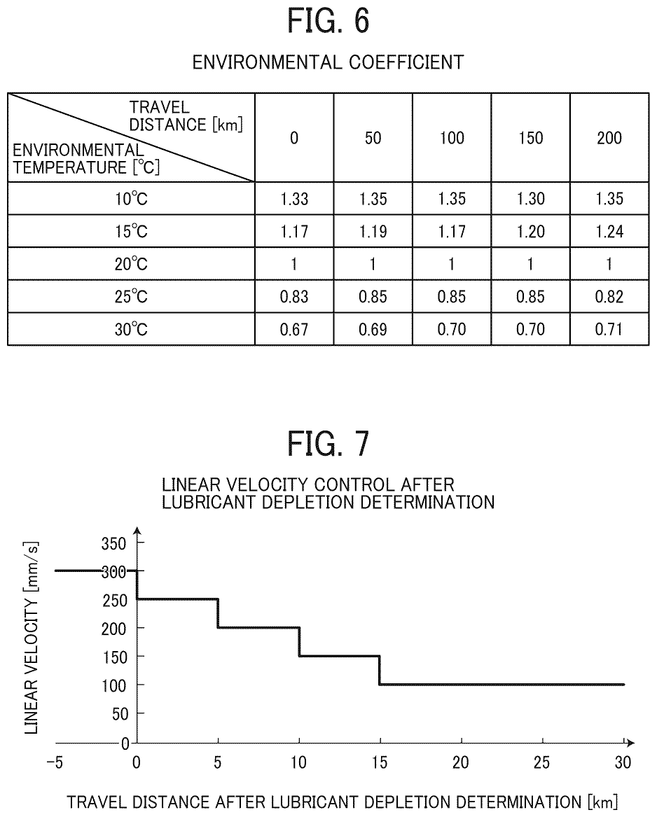

FIG. 3 is a diagram illustrating a configuration of functional blocks in the image forming apparatus according to the first embodiment. FIG. 4 is a diagram illustrating a relationship between a travel distance and a lubricant consumption rate. FIG. 5 is a diagram illustrating a lookup table of a lubricant consumption rate associated with a travel distance and an environmental temperature. FIG. 6 is a diagram illustrating a lookup table of environmental coefficients associated with the travel distance and the environmental temperature. A description is given below of the configuration of the functional blocks of the image forming apparatus 1 with reference to FIGS. 3 to 6.

As illustrated in FIG. 3, the controller 910 of the image forming apparatus 1 includes an acquisition unit 201, a count unit 202, a prediction unit 203, a determination unit 204, a print control unit 205, a display control unit 206, and a storage unit 207.

The acquisition unit 201 is a functional unit that acquires the temperature (hereinafter, it may be referred to as an environmental temperature) of the use environment of the intermediate transfer belt 51 detected by the temperature sensor 960.

The count unit 202 is a functional unit that counts a travel distance of the moving operation of the intermediate transfer belt 51. Specifically, the count unit 202 counts the accumulated travel distance since the maintenance including the latest replenishment of the lubricant has been performed in the image forming apparatus 1 and each travel distance (hereinafter, it may be referred to as a job travel distance) of the intermediate transfer belt 51 accompanying the execution of each job. The count unit 202 may acquire and count information regarding the travel distance via the engine control unit 930, for example. The count unit 202 may count the number of recording sheets P printed by the engine control unit 930 as the travel distance.

The prediction unit 203 is a functional unit that predicts the consumption amount (hereinafter, it may be referred to as a lubricant consumption amount) of the lubricant in the intermediate transfer belt 51 based on the environmental temperature acquired by the acquisition unit 201 and the travel distance counted by the count unit 202.

Here, an example of the relationship between the travel distance [km] and the consumption rate (hereinafter, it may be referred to as a lubricant consumption rate) [mg/km] of the lubricant is illustrated in FIG. 4. The travel distance in FIG. 4 indicates a travel distance after maintenance including replenishment of lubricant has been performed most recently. As illustrated in FIG. 4, the lubricant consumption rate decreases as the travel distance increases. That is, the lubricant consumption rate gradually decreases as the use period of the image forming apparatus 1 elapses. As illustrated in FIG. 4, the lubricant consumption rate decreases as the environmental temperature [°C] increases.

Regarding such a lubricant consumption rate, FIG. 5 illustrates a lookup table for extracting a lubricant consumption rate associated with a travel distance and an environmental temperature. This lookup table is stored in the storage unit 207. In this case, the prediction unit 203 refers to the lookup table stored in the storage unit 207, and acquires the lubricant consumption rate corresponding to the environmental temperature acquired by the acquisition unit 201 and the travel distance (the accumulated travel distance) counted by the count unit 202. Next, the prediction unit 203 multiplies the acquired lubricant consumption rate by the job travel distance counted by the count unit 202 to predict the lubricant consumption amount due to the execution of the job. Furthermore, the prediction unit 203 adds the lubricant consumption amount due to the execution of the job calculated above to the lubricant consumption amount (hereinafter, it may be referred to as a cumulative lubricant consumption amount) accumulated after maintenance including the latest replenishment of the lubricant, thereby predicting the latest cumulative lubricant consumption amount. The cumulative lubricant consumption amount corresponds to the “cumulative consumption amount” of the present disclosure.

Instead of the lookup table of the lubricant consumption rate illustrated in FIG. 5 stored in the storage unit 207, the lookup table of the environmental coefficient illustrated in FIG. 6 may be used. The lookup table illustrated in FIG. 6 is a lookup table for retrieving environmental coefficients associated with a travel distance and the environmental temperature. Here, the environmental coefficient is a value obtained by dividing a lubricant consumption rate at each environmental temperature in a specific travel distance by a lubricant consumption rate at an environmental temperature (for example, 20 [°C]) as a reference in the specific travel distance. Therefore, when the reference environmental temperature is 20 [°C] and the lubricant consumption rate corresponding to each travel distance in the case of 20 [°C] is known, the lubricant consumption amount due to execution of the job can be predicted by acquiring the environmental coefficient with reference to the lookup table illustrated in FIG. 6. That is, the prediction unit 203 refers to the lookup table illustrated in FIG. 6 stored in the storage unit 207, and acquires the environmental coefficient corresponding to the environmental temperature acquired by the acquisition unit 201 and the travel distance (the accumulated travel distance) counted by the count unit 202. Next, the prediction unit 203 calculates the lubricant consumption rate at the environmental temperature acquired by the acquisition unit 201 by multiplying the acquired environmental coefficient by the known lubricant consumption rate of 20 [°C] corresponding to the accumulated travel distance described above. Next, the prediction unit 203 multiplies the calculated lubricant consumption rate by the job travel distance counted by the count unit 202 to predict the lubricant consumption amount due to the execution of the job. Furthermore, the prediction unit 203 can predict the latest cumulative lubricant consumption amount by adding the lubricant consumption amount obtained by executing the job calculated above to the cumulative lubricant consumption amount.

The determination unit 204 is a functional unit that determines whether the cumulative lubricant consumption amount predicted by the prediction unit 203 has become equal to or more than the maximum capacity (hereinafter, it may be referred to as lubricant capacity) of the lubricant loadable in the image forming apparatus 1. That is, when the cumulative lubricant consumption amount has become equal to or more than the lubricant capacity, the determination unit 204 determines that the lubricant supplied to the intermediate transfer belt 51 is depleted.

The print control unit 205 is a functional unit that controls the printing operation on the recording sheet P via the engine control unit 930. Specifically, when the determination unit 204 determines that the cumulative lubricant consumption amount has become equal to or more than the lubricant capacity (that is, when the lubricant is depleted), the print control unit 205 performs control to reduce linear velocity of the image forming apparatus 1 in order to delay the progress speed of the job.

As a result, by decreasing the operation speed of the image forming apparatus 1 instead of stopping the image forming apparatus 1, the user can feel the decrease, and can understand the necessity of maintenance such as supply of lubricant. Here, the linear velocity indicates the speed of the printing process of the image forming apparatus 1, and is specifically determined by, for example, the paper feeding speed in the fixing device 90. Control of the linear velocity by the print control unit 205 will be described later with reference to FIG. 7.

The display control unit 206 is a functional unit that controls display operation of the operation panel 940. Specifically, when the determination unit 204 determines that the cumulative lubricant consumption amount has become equal to or more than the lubricant capacity, the display control unit 206 causes the operation panel 940 to display that maintenance is necessary due to the shortage of the lubricant. As a result, the user can visually understand the necessity of maintenance such as supply of lubricant.

The storage unit 207 is a functional unit that stores the lookup table and the like illustrated in FIG. 5 or 6. The storage unit 207 is implemented by the HD 909 illustrated in FIG. 2.

The acquisition unit 201, the count unit 202, the prediction unit 203, the determination unit 204, the print control unit 205, and the display control unit 206 described above are implemented, for example, by executing a program by the CPU 901 illustrated in FIG. 2. At least a part of the acquisition unit 201, the count unit 202, the prediction unit 203, the determination unit 204, the print control unit 205, and the display control unit 206 may be implemented by a hardware circuit such as a field-programmable gate array (FPGA) or an application specific integrated circuit (ASIC).

Note that the functional units of the controller 910 illustrated in FIG. 3 conceptually illustrate functions, and the configuration of the controller is not limited to such a configuration. That is, the functional units of the controller 910 do not have to be configured as clear software modules as blocks illustrated in FIG. 3, and it is sufficient that the functions of the functional units are implemented as a whole by executing a program by the CPU 901 of the controller 910. For example, the plurality of functional units illustrated as independent functional units in the controller 910 illustrated in FIG. 3 may be configured as one functional unit. On the other hand, a function of one functional unit in the controller 910 illustrated in FIG. 3 may be divided into a plurality of parts and configured as a plurality of functional units.

### Linear Velocity Control After Lubricant Depletion Determination in Image Forming Apparatus

FIG. 7 is a diagram illustrating an operation of the linear velocity control after the lubricant depletion determination in the image forming apparatus according to the first embodiment. The operation of the linear velocity control after the lubricant depletion determination in the image forming apparatus 1 according to the present embodiment will be described with reference to FIG. 7.

As described above, when the determination unit 204 determines that the cumulative lubricant consumption amount has become equal to or more than the lubricant capacity, the print control unit 205 may decrease the linear velocity stepwise in accordance with the increase in the travel distance after the above-described determination, for example, as illustrated in FIG. 7, in order to decrease the linear velocity of the image forming apparatus 1. As a result, the user can strongly feel a decrease in the operation speed of the image forming apparatus 1, and can understand the necessity of maintenance such as supply of lubricant.

As described above, in the image forming apparatus 1 according to the present embodiment, the count unit 202 counts the travel distance of the intermediate transfer belt 51, the prediction unit 203 predicts the cumulative consumption amount of the lubricant in the intermediate transfer belt 51 based on the travel distance counted by the count unit 202, the determination unit 204 determines whether the cumulative consumption amount predicted by the prediction unit 203 is equal to or more than the predetermined amount, and the print control unit 205 delays the progress speed of the job when the determination unit 204 determines that the cumulative consumption amount is equal to or more than the predetermined amount. Specifically, the print control unit 205 reduces the linear velocity of the image forming apparatus 1 when the determination unit 204 determines that the cumulative consumption amount is equal to or more than the predetermined amount. As a result, by decreasing the operation speed of the image forming apparatus 1 instead of stopping the image forming apparatus 1, the user can feel the decrease, and can understand the necessity of maintenance such as supply of lubricant. Then, turnover of the cleaning blade can be suppressed while using the lubricant until almost fully consumed, and a decrease in work efficiency due to sudden stop of the device can be suppressed.

When the determination unit 204 determines that the cumulative lubricant consumption amount has become equal to or more than the lubricant capacity, the print control unit 205 may repeat the operation of temporarily stopping the printing operation and resuming the printing operation during the execution of the job in order to delay the progress speed of the job instead of decreasing the linear velocity. Also in this case, the user can feel a decrease in the operation speed of the image forming apparatus 1, and can understand the necessity of maintenance such as supply of lubricant.

### Second Embodiment

A description is given of an image forming apparatus 1 according to a second embodiment, regarding the difference from the image forming apparatus 1 according to the first embodiment. In the present embodiment, an operation of dividing a job, stopping the intermediate transfer belt 51 every time the divided job is executed, reversing the intermediate transfer belt by a predetermined amount, and then executing the divided next job will be described repeatedly. An overall configuration, a hardware configuration, and a configuration of functional blocks in the image forming apparatus 1 according to the present embodiment are similar or identical to those described in the first embodiment.

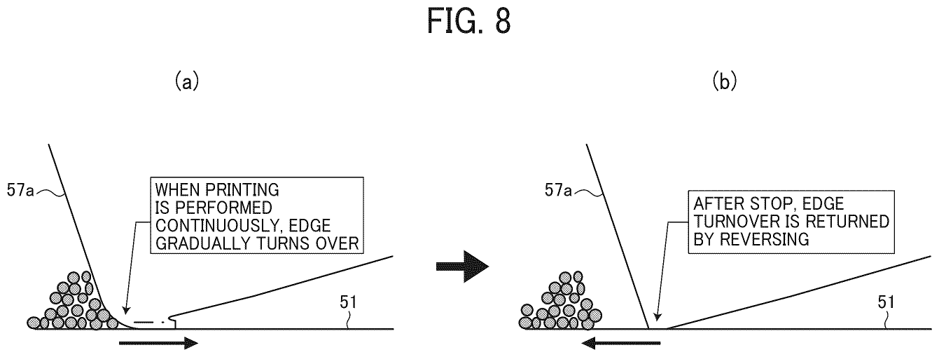

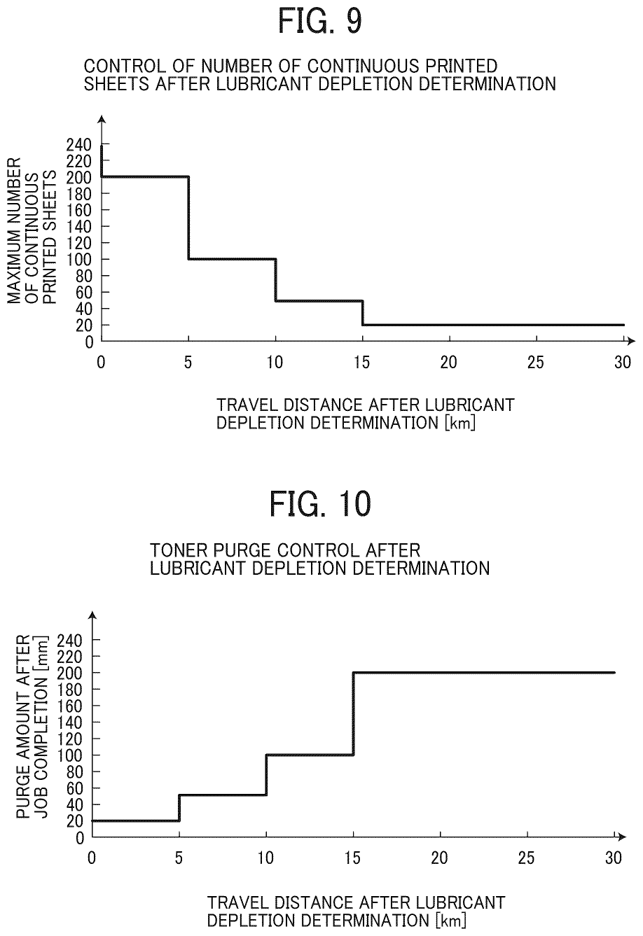

FIG. 8 is a diagram describing turnover of the cleaning blade and remedy thereof in the image forming apparatus according to the second embodiment. FIG. 9 is a diagram illustrating an operation of control of the number of continuous printed sheets after the lubricant depletion determination in the image forming apparatus according to the second embodiment. With reference to FIGS. 8 and 9, a description will be given of operation of the image forming apparatus 1 according to the present embodiment.

In the present embodiment, when the determination unit 204 determines that the cumulative lubricant consumption amount has become equal to or more than the lubricant capacity (that is, when the lubricant is depleted), the print control unit 205 repeats an operation of dividing the job to be executed, stopping the intermediate transfer belt 51 every time the divided job is executed and then reversing the intermediate transfer belt by a predetermined amount, and then executing the divided next job, in order to delay the progress speed of the job. By dividing and executing the job without continuously executing the job in this manner, the user can feel a decrease in the speed of job execution, can understand the necessity of maintenance such as supply of lubricant, and can suppress the progress of deformation of the edge of the cleaning blade 57a. In addition, by reversing the intermediate transfer belt 51 by a predetermined amount after the intermediate transfer belt 51 is stopped as illustrated in (b) of FIG. 8 from the state in which the intermediate transfer belt rotates in the normal direction as illustrated in (a) of FIG. 8, the turnover of the cleaning blade 57a can be alleviated by the returning effect of the cleaning blade 57a.

Furthermore, as illustrated in FIG. 9, after the determination unit 204 determines that the cumulative lubricant consumption amount has become equal to or more than the lubricant capacity, the print control unit 205 may decrease the maximum number of continuous printed sheets for each divided job stepwise in accordance with the increase in the travel distance counted by the count unit 202. Then, in FIG. 9, the print control unit 205 repeats an operation of dividing the job to be executed so as to perform printing for each maximum number of continuous printed sheets corresponding to the current travel distance, stopping the intermediate transfer belt 51 every time the divided job (maximum number of continuous printed sheets) is executed and then reversing the intermediate transfer belt by a predetermined amount, and then executing the divided next job.

As a result, since the frequency of the reversing operation of the intermediate transfer belt 51 increases as the travel distance increases, the user can strongly feel a decrease in the operation speed of the image forming apparatus 1, and can understand the necessity of maintenance such as supply of lubricant.

Note that the amount of reversing of the intermediate transfer belt 51 after execution of the divided job may be increased in accordance with an increase in the travel distance.

### Third Embodiment

A description is given of an image forming apparatus 1 according to a third embodiment, regarding the difference from the image forming apparatus 1 according to the first embodiment. In the present embodiment, an operation of supplying a full-surface toner image to the intermediate transfer belt 51 after executing a job in conjunction with reducing the linear velocity of the image forming apparatus 1 after it is determined that the lubricant is depleted will be described. An overall configuration, a hardware configuration, and a configuration of functional blocks in the image forming apparatus 1 according to the present embodiment are similar or identical to those described in the first embodiment.

FIG. 10 is a diagram illustrating an operation of toner purge control after lubricant depletion determination in the image forming apparatus according to the third embodiment. With reference to FIG. 10, a description will be given of operation of the image forming apparatus 1 according to the present embodiment.

In the present embodiment, when the determination unit 204 determines that the cumulative lubricant consumption amount has become equal to or more than the lubricant capacity (that is, when the lubricant is depleted), the print control unit 205 performs an operation of supplying the full-surface toner image to the intermediate transfer belt 51 after executing the job in conjunction with reducing the linear velocity of the image forming apparatus 1 as described in the first embodiment. As a result, the user can feel a decrease in the speed of job execution, and can understand the necessity of maintenance such as supply of lubricant, and the toner is supplied to the cleaning blade 57a by the full-surface toner image, so that the occurrence of turnover of the cleaning blade 57a can be suppressed.

The supply operation of the full-surface toner image described above is not limited to being executed together with reducing the linear velocity of the image forming apparatus 1 as described in the first embodiment, and may be executed in conjunction with repeating an operation of temporarily stopping the printing operation and then resuming the printing operation in the middle of execution of the job in the first embodiment, or in conjunction with dividing the job, stopping the intermediate transfer belt 51 every time the divided job is executed and then reversing the intermediate transfer belt by a predetermined amount, and then executing the divided next job as described in the second embodiment.

Furthermore, as illustrated in FIG. 10, after the determination unit 204 determines that the cumulative lubricant consumption amount has become equal to or more than the lubricant capacity, the print control unit 205 may increase the purge amount of toner for forming the full-surface toner image stepwise in accordance with the increase in the travel distance counted by the count unit 202. Accordingly, the occurrence of turnover of the cleaning blade 57a can be further suppressed.

In the above-described embodiments, in a case where at least one of the functional units of the controller 910 of the image forming apparatus 1 is implemented by execution of a program, the program is provided by being incorporated in advance in a ROM or the like. Alternatively, in the above-described embodiments, the program executed by the controller 910 of the image forming apparatus 1 may be stored, in an installable or executable file format, in a computer readable recording medium, such as a compact disc read only memory (CD-ROM), a flexible disk (FD), a compact disc-recordable (CD-R), and a digital versatile disc (DVD). In the above-described embodiments, the program executed by the controller 910 of the image forming apparatus 1 may be stored on a computer connected to a network such as the Internet and provided by being downloaded via the network. In the above-described embodiments, the program executed by the controller 910 of the image forming apparatus 1 may be provided or distributed via a network such as the Internet. In the above-described embodiments, the program executed by the controller 910 of the image forming apparatus 1 has a module configuration including at least one of the above-described functional units, and as actual hardware, the CPU 901 reads and executes the program from the above-described storage device, so that the above-described functional units are loaded and generated on a main storage device.

A description is given below of some aspects of the present disclosure.

### Aspect 1

According to Aspect 1, an image forming apparatus includes: a photoconductor drum; an image forming unit to develop a toner image on the photoconductor drum; an intermediate transfer belt to which the toner image is primarily transferred from the photoconductor drum; a cleaning blade to remove toner remaining on the intermediate transfer belt; a count unit configured to count a travel distance of the intermediate transfer belt; a prediction unit configured to predict a cumulative consumption amount of the lubricant on the intermediate transfer belt based on the travel distance counted by the count unit; a determination unit configured to determine whether the cumulative consumption amount predicted by the prediction unit is equal to or more than a predetermined amount; and a print control unit configured to delay a progress speed of a job when the determination unit determines that the cumulative consumption amount is equal to or more than the predetermined amount.

### Aspect 2

According to Aspect 2, in the image forming apparatus of Aspect 1, when the determination unit determines that the cumulative consumption amount is equal to or more than the predetermined amount, the print control unit reduces linear velocity of the image forming apparatus.

### Aspect 3

According to Aspect 3, in the image forming apparatus of Aspect 2, after the determination unit determines that the cumulative consumption amount is equal to or more than the predetermined amount, the print control unit reduces the linear velocity of the image forming apparatus stepwise in accordance with an increase in the travel distance counted by the count unit.

### Aspect 4

According to Aspect 4, in the image forming apparatus of Aspect 1, when the determination unit determines that the cumulative consumption amount is equal to or more than the predetermined amount, the print control unit repeats an operation of temporarily stopping a printing operation in middle of execution of the job and resuming the printing operation.

### Aspect 5

According to Aspect 5, in the image forming apparatus of Aspect 1, when the determination unit determines that the cumulative consumption amount is equal to or more than the predetermined amount, the print control unit repeats an operation of dividing the job, stopping the intermediate transfer belt every time a divided job is executed, reversing the intermediate transfer belt by a predetermined amount, and then executing a next divided job.

### Aspect 6

According to Aspect 6, in the image forming apparatus of Aspect 5, after the determination unit determines that the cumulative consumption amount is equal to or more than the predetermined amount, the print control unit decreases a maximum number of continuous printed sheets for each divided job stepwise in accordance with an increase in the travel distance counted by the count unit.

### Aspect 7

According to Aspect 7, in the image forming apparatus of Aspect 5, after the determination unit determines that the cumulative consumption amount is equal to or more than the predetermined amount, the print control unit increases frequency of reversing operation of the intermediate transfer belt in accordance with an increase in the travel distance counted by the count unit.

### Aspect 8

According to Aspect 8, in the image forming apparatus of any one of Aspect 5 to Aspect 7, after the determination unit determines that the cumulative consumption amount is equal to or more than the predetermined amount, the print control unit increases a reversing amount of the intermediate transfer belt after execution of the divided job in accordance with an increase in the travel distance counted by the count unit.

### Aspect 9

According to Aspect 9, in the image forming apparatus of any one of Aspect 2 to Aspect 8, when the determination unit determines that the cumulative consumption amount is equal to or more than the predetermined amount, the print control unit further supplies a predetermined toner image to the intermediate transfer belt after execution of a job.

### Aspect 10

According to Aspect 10, in the image forming apparatus of Aspect 9, after the determination unit determines that the cumulative consumption amount is equal to or more than the predetermined amount, the print control unit increases a purge amount of toner for supplying the toner image to the intermediate transfer belt stepwise in accordance with an increase in the travel distance counted by the count unit.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

1. An image forming apparatus comprising:
a photoconductor drum;
an image forming unit to develop a toner image on the photoconductor drum;
an intermediate transfer belt to which the toner image is primarily transferred from the photoconductor drum;
a cleaning blade to remove toner remaining on the intermediate transfer belt; and
circuitry configured to:
count a travel distance of the intermediate transfer belt;
predict a cumulative consumption amount of a lubricant on the intermediate transfer belt based on the travel distance counted;
determine whether the cumulative consumption amount predicted is equal to or more than a predetermined amount; and
delay a progress speed of a job when the cumulative consumption amount is determined to be equal to or more than the predetermined amount.

2. The image forming apparatus according to claim 1, wherein when the circuitry determines that the cumulative consumption amount is equal to or more than the predetermined amount, the circuitry reduces linear velocity of the image forming apparatus.

3. The image forming apparatus according to claim 2, wherein after the circuitry determines that the cumulative consumption amount is equal to or more than the predetermined amount, the circuitry reduces the linear velocity of the image forming apparatus stepwise in accordance with an increase in the travel distance counted.

4. The image forming apparatus according to claim 1, wherein when the circuitry determines that the cumulative consumption amount is equal to or more than the predetermined amount, the circuitry repeats an operation of temporarily stopping a printing operation in middle of execution of the job and resuming the printing operation.

5. The image forming apparatus according to claim 1, wherein when the circuitry determines that the cumulative consumption amount is equal to or more than the predetermined amount, the circuitry repeats an operation of dividing the job, stopping the intermediate transfer belt every time a divided job is executed, reversing the intermediate transfer belt by a predetermined amount, and then executing a next divided job.

6. The image forming apparatus according to claim 5, wherein after the circuitry determines that the cumulative consumption amount is equal to or more than the predetermined amount, the circuitry decreases a maximum number of continuous printed sheets for each divided job stepwise in accordance with an increase in the travel distance counted.

7. The image forming apparatus according to claim 5, wherein after the circuitry determines that the cumulative consumption amount is equal to or more than the predetermined amount, the circuitry increases frequency of reversing operation of the intermediate transfer belt in accordance with an increase in the travel distance counted.

8. The image forming apparatus according to claim 5, wherein after the circuitry determines that the cumulative consumption amount is equal to or more than the predetermined amount, the circuitry increases a reversing amount of the intermediate transfer belt after execution of the divided job in accordance with an increase in the travel distance counted.

9. The image forming apparatus according to claim 2, wherein when the circuitry determines that the cumulative consumption amount is equal to or more than the predetermined amount, the circuitry further supplies a predetermined toner image to the intermediate transfer belt after execution of a job.

10. The image forming apparatus according to claim 9, wherein after the circuitry determines that the cumulative consumption amount is equal to or more than the predetermined amount, the circuitry increases a purge amount of toner for supplying the toner image to the intermediate transfer belt stepwise in accordance with an increase in the travel distance counted.

11. An image forming apparatus comprising:
a photoconductor drum;
an image forming unit to develop a toner image on the photoconductor drum;
an intermediate transfer belt to which the toner image is primarily transferred from the photoconductor drum;
a cleaning blade to remove toner remaining on the intermediate transfer belt;
a count unit to count a travel distance of the intermediate transfer belt;
a prediction unit to predict a cumulative consumption amount of a lubricant on the intermediate transfer belt based on the travel distance counted;
a determination unit to determine whether the cumulative consumption amount predicted is equal to or more than a predetermined amount; and
a print control unit to delay a progress speed of a job when the cumulative consumption amount is determined to be equal to or more than the predetermined amount.

12. The image forming apparatus according to claim 11, wherein when the determination unit determines that the cumulative consumption amount is equal to or more than the predetermined amount, the print control unit reduces linear velocity of the image forming apparatus.

13. The image forming apparatus according to claim 12, wherein after the determination unit determines that the cumulative consumption amount is equal to or more than the predetermined amount, the print control unit reduces the linear velocity of the image forming apparatus stepwise in accordance with an increase in the travel distance counted by the count unit.

14. The image forming apparatus according to claim 11, wherein when the determination unit determines that the cumulative consumption amount is equal to or more than the predetermined amount, the print control unit repeats an operation of temporarily stopping a printing operation in middle of execution of the job and resuming the printing operation.

15. The image forming apparatus according to claim 11, wherein when the determination unit determines that the cumulative consumption amount is equal to or more than the predetermined amount, the print control unit repeats an operation of dividing the job, stopping the intermediate transfer belt every time a divided job is executed, reversing the intermediate transfer belt by a predetermined amount, and then executing a next divided job.

16. The image forming apparatus according to claim 15, wherein after the determination unit determines that the cumulative consumption amount is equal to or more than the predetermined amount, the print control unit decreases a maximum number of continuous printed sheets for each divided job stepwise in accordance with an increase in the travel distance counted by the count unit.

17. The image forming apparatus according to claim 15, wherein after the determination unit determines that the cumulative consumption amount is equal to or more than the predetermined amount, the print control unit increases frequency of reversing operation of the intermediate transfer belt in accordance with an increase in the travel distance counted by the count unit.

18. The image forming apparatus according to claim 15, wherein after the determination unit determines that the cumulative consumption amount is equal to or more than the predetermined amount, the print control unit increases a reversing amount of the intermediate transfer belt after execution of the divided job in accordance with an increase in the travel distance counted by the count unit.

19. The image forming apparatus according to claim 12, wherein when the determination unit determines that the cumulative consumption amount is equal to or more than the predetermined amount, the print control unit further supplies a predetermined toner image to the intermediate transfer belt after execution of a job.

20. The image forming apparatus according to claim 19, wherein after the determination unit determines that the cumulative consumption amount is equal to or more than the predetermined amount, the print control unit increases a purge amount of toner for supplying the toner image to the intermediate transfer belt stepwise in accordance with an increase in the travel distance counted by the count unit.
